(19) United States
(12) Patent Application Publication
(10) Pub. No.: US 2011/0046987 A1
(43) Pub. Date: Feb. 24, 2011

(54) Method and system for virtual inflight reservation of post-flight resources

(76) Inventor: Gregory C. Petrisor, Los Angeles, CA (US)

Correspondence Address: Scot A. Reader, Esq., Suite 228, 1320 Pearl Street, Boulder, CO, 80302, US

(21) Appl. No.: 12/806,917

(22) Filed: Aug. 24, 2010

Related U.S. Application Data
(60) Provisional application No. 61/274,987, filed on Aug. 24, 2009.

(51) Int. Cl. G06Q 10/00; G06F 3/01; G06F 15/16

(52) U.S. Cl. 705/5; 715/738

(57) ABSTRACT

Methods and systems for virtual inflight reservation and a reservation manager for use therein allow passengers to effectively reserve post-flight resources while in-flight, and without having connectivity to a terrestrial communication network. In exemplary operation, before departure, a flight is allocated certain resources and a temporary hold is placed in a terrestrial reservation system on these resources. While in-flight, passengers reserve desired resources within the temporarily held resources. These reservations are “virtual” since they have not yet been processed by the terrestrial reservation system, although the temporary hold guarantees that the post-flight resource will be available when the reservation is later processed by the terrestrial reservation system. After the flight arrives at its destination, the reservations are processed by the terrestrial reservation system.

### CROSS-REFERENCE TO RELATED APPLICATION

This application claims the benefit of U.S. provisional application No. 61/274,987 entitled “METHOD AND SYSTEM FOR VIRTUAL INFLIGHT RESERVATION OF POST-FLIGHT RESOURCES,” filed on Aug. 24, 2009, the contents of which are incorporated herein by reference.

### BACKGROUND OF THE INVENTION

The present invention relates to resource reservation and, more particularly, to methods and systems that allow passengers to effectively reserve post-flight resources while in-flight and without having connectivity to a terrestrial communication network.

Airline passengers often desire to reserve post-flight resources, such as seats on future flights, rental cars and hotel rooms. However, some inflight communication systems do not offer passenger connectivity while in-flight to terrestrial communication networks (e.g. the Internet) that support reservation systems for such resources, and other inflight communication systems offer such connectivity only to passengers who are willing to pay a connectivity charge. Accordingly, there are practical and economic barriers to a passenger's ability to reserve a post-flight resource while in-flight. These barriers can be a source of frustration for the passenger, who must disembark from the flight and establish alternative connectivity before making a reservation. Moreover, by that time, a resource that was available while the passenger was in-flight may have become unavailable or may have increased in cost.

Meanwhile, it is known that reservation systems for such resources allow authorized entities to hold such resources for a limited time without charge. Such a temporary hold prevents the resources from being reserved by another entity while the hold is in place, and is lifted when the resources are explicitly released by the authorized entity or after expiration of a given time window.

### SUMMARY OF THE INVENTION

The present invention, in a basic feature, provides methods and systems for virtual inflight reservation and a reservation manager for use therein that allow passengers to effectively reserve post-flight resources while in-flight, and without having connectivity to a terrestrial communication network. In exemplary operation, before departure, a flight is allocated certain resources and a temporary hold is placed in a terrestrial reservation system on these resources. While in-flight, passengers reserve desired resources within the temporarily held resources. These reservations are “virtual” since they have not yet been processed by the terrestrial reservation system, although the temporary hold guarantees that the post-flight resource will be available when the reservation is later processed by the terrestrial reservation system. After the flight arrives at its destination, the reservations are processed by the terrestrial reservation system.

In one aspect of the invention, a method for virtual inflight reservation comprises the steps of receiving by a reservation manager from a terrestrial reservation system information about temporarily held post-flight resources, transmitting by the reservation manager to a passenger interface on an inflight communication network information about at least one resource within the temporarily held post-flight resources, receiving by the reservation manager from the passenger interface a virtual reservation request for the resource and transmitting by the reservation manager to the terrestrial reservation system an actual reservation request for the resource based on the virtual reservation request.

In some embodiments, the reservation manager is connected to the terrestrial reservation system during the first receiving step and the second transmitting step and is disconnected from the terrestrial reservation system during the second receiving step and the first transmitting step.

In some embodiments, the reservation manager is operative on an airplane, and wherein the first receiving step and the second transmitting step are performed while the airplane is on the ground whereas the second receiving step and the first transmitting step are performed while the airplane is in-flight.

In some embodiments, the temporarily held post-flight resources comprise at least one of a flight seat, a rental car or a hotel room.

In some embodiments, the virtual reservation request comprises an identity of a passenger requesting a reservation and an identity of the resource.

In some embodiments, the virtual reservation request further comprises payment information.

In some embodiments, the virtual reservation request further comprises a post-flight contact address for the passenger.

In some embodiments, the method further comprises the step of verifying by the reservation manager that the virtual reservation request does not conflict with an existing virtual reservation.

In some embodiments, the method further comprises the step of storing by the reservation manager information from the virtual reservation request in a virtual reservations database.

In some embodiments, the method further comprises the step of transmitting by the reservation manager to the passenger interface in response to the virtual reservation request a virtual reservation acceptance for the resource.

In some embodiments, the method further comprises the step of receiving by the reservation manager from the terrestrial reservation system an actual reservation acceptance for the resource.

In some embodiments, the method further comprises the step of transmitting by the reservation manager to the passenger interface an actual reservation acceptance for the resource.

In some embodiments, the method further comprises the step of transmitting by the reservation manager to the terrestrial reservation system a request to release a temporary hold on resources within the temporarily held post-flight resources.

In another aspect of the invention, a virtual inflight reservation system comprises a reservation manager and a passenger interface, wherein the reservation manager transmits to the passenger interface information about at least one resource within temporarily held post-flight resources identified to the reservation manager by a terrestrial reservation system, and wherein the reservation manager transmits to the terrestrial reservation system an actual reservation request for the resource based on a virtual reservation request for the resource received from the passenger interface and accepted by the reservation manager.

In yet another aspect of the invention, a reservation manager for a virtual inflight reservation system comprises a terrestrial network interface, an inflight network interface and a processor communicatively coupled with the terrestrial network interface and the inflight network interface, wherein under control of the processor the reservation manager transmits on the inflight network interface information about at least one resource within temporarily held post-flight resources identified to the reservation manager over the terrestrial network interface, and wherein under control of the processor the reservation manager transmits on the terrestrial network interface an actual reservation request for the resource based on a virtual reservation request for the resource received on the inflight network interface.

These and other aspects of the invention will be better understood when taken in conjunction with the detailed description of the preferred embodiment and the drawings that are briefly described below.

### BRIEF DESCRIPTION OF THE DRAWINGS

FIG. 1 shows a virtual inflight reservation system in some embodiments of the invention.

FIG. 2 shows a reservation manager of a virtual inflight reservation system in some embodiments of the invention.

FIG. 3 shows software and data elements operative on the reservation manager of FIG. 2.

FIG. 4 shows a virtual inflight reservation method in some embodiments of the invention.

### DETAILED DESCRIPTION OF A PREFERRED EMBODIMENT

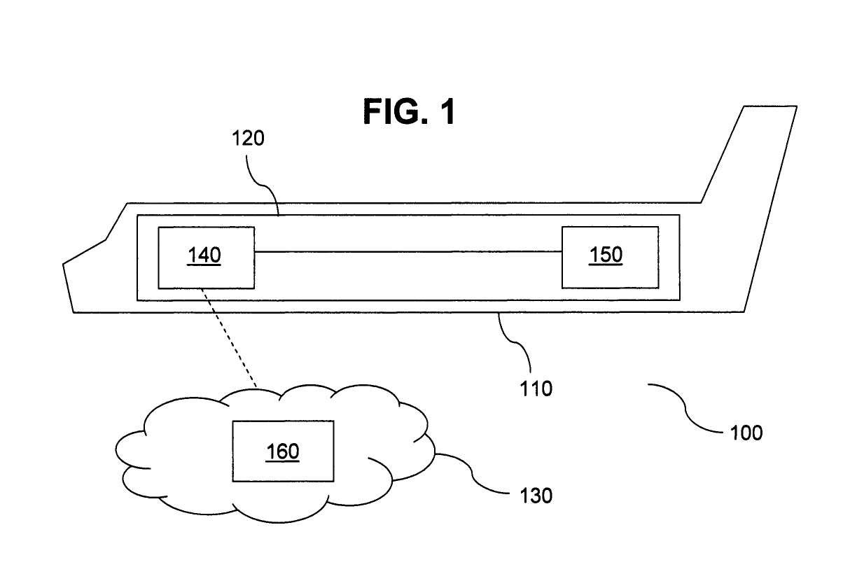

FIG. 1 shows a virtual inflight reservation system 100 in some embodiments of the invention. System 100 includes an inflight communication network 120 that is communicatively coupled with a terrestrial communication network 130 via a wireless connection. Inflight communication network 120 is operative on an airplane 110 and includes a reservation manager 140 communicatively coupled with a passenger interface 150 via a wired or wireless network connection. Passenger interface 150 includes an output interface, such as a user screen and an input interface, such as a touch screen and/or keypad, which may be integral with passenger seating or may be a portable device such as a laptop computer, smart phone or personal data assistant (PDA). Passenger interface 150 may also include a credit card reader. Typically, reservation manager 140 is communicatively coupled with other passenger interfaces (not shown) as well. In some embodiments, reservation manager 140 operates at the head end and passenger interface 150 operates at the seat end of an inflight entertainment system. Terrestrial communication network 130 includes a terrestrial reservation system 160.

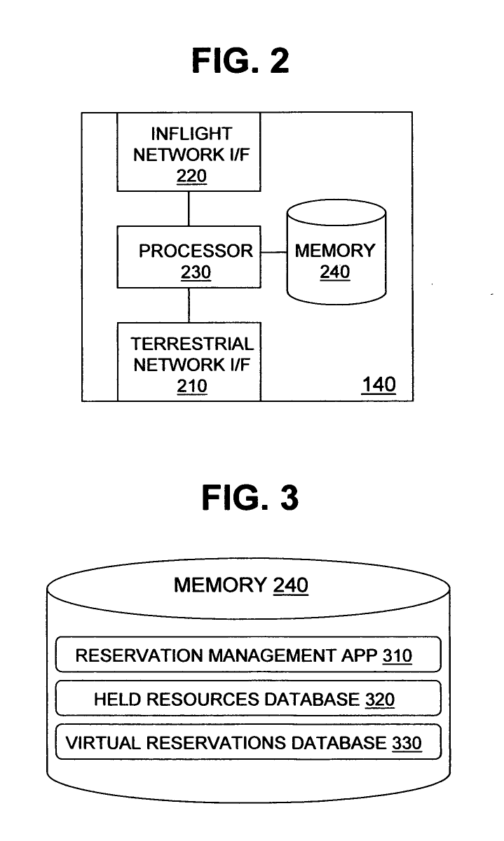

FIG. 2 shows reservation manager 140 in some embodiments of the invention. Manager 140 includes a terrestrial network interface 210, an inflight network interface 220 and a memory 240, all of which are communicatively coupled with a processor 230. Terrestrial network interface 210 is a wireless network interface that connects to and transmits and receives data over terrestrial communication network 130 when airplane 110 is on the ground (e.g. prior to departure and after arrival). Inflight network interface 220 is a wired or wireless network interface that transmits and receives data over inflight communication network 120 when airplane 110 is in-flight and when inflight communication network 120 is otherwise operational. Processor 230 executes software stored in memory 240 to interface with terrestrial communication network 130 and inflight communication network 120 in a reservation management role, and manage data storage and retrieval from memory 240.

FIG. 3 shows software and data elements operative on reservation manager 140. Reservation management application 310 is software executable by processor 230 that supports a reservation management role, including interfacing with reservation management system 160 to discover temporarily held post-flight resources, interfacing with passenger interface 150 to advertise temporarily held post-flight resources and accept virtual reservations for post-flight resources, and interfacing with reservation management system 160 to make actual reservations for post-flight resources corresponding to accepted virtual reservations. Held resources database 320 is a storage element that maintains information on temporarily held post-flight resources. Virtual reservations database 330 is a storage element that maintains information on accepted virtual reservations for post-flight resources.

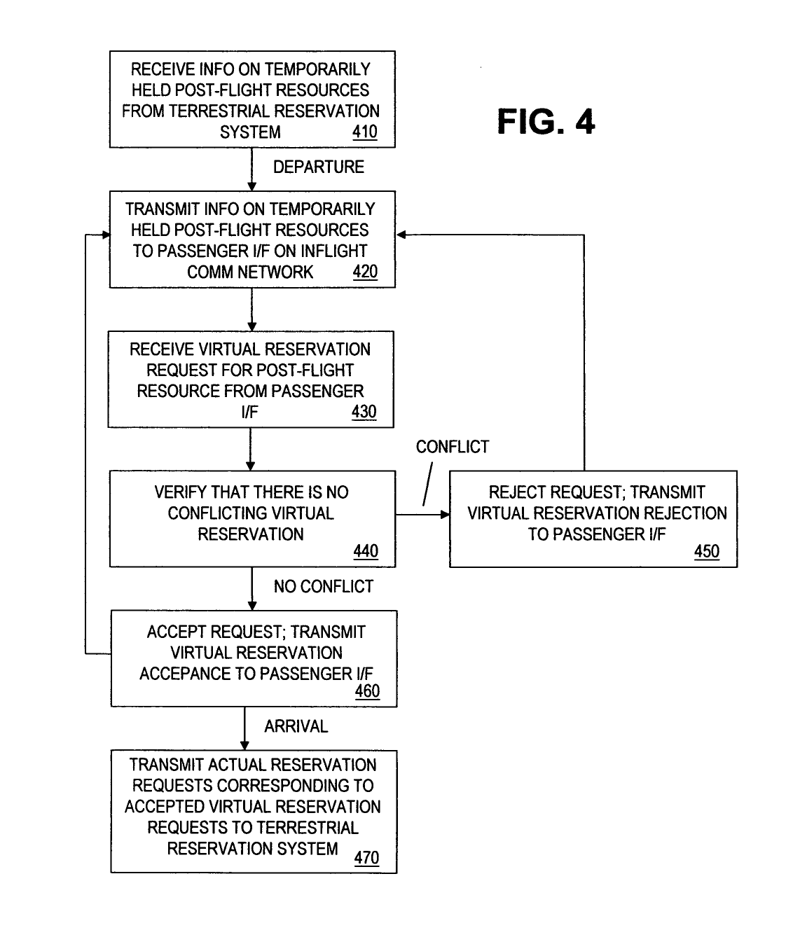

FIG. 4 shows a virtual inflight reservation method performed by reservation manager 140 under control of processor 230 in some embodiments of the invention. Prior to departure of airplane 110 on a scheduled flight, reservation manager 140 establishes a wireless connection with terrestrial reservation system 160 on terrestrial communication network 130 and receives information about temporarily held post-flight resources from terrestrial reservation system 160 via terrestrial network interface 210 (410). The received information may include a list of post-flight resources, such as flight seats (e.g. airline, flight number, departure/arrival city, departure/arrival time, price, seat number), rental cars (e.g. rental car company, city, date/time, car classification, price) and/or hotel rooms (e.g. hotel name/address, date, price), that have been allocated to the flight and temporarily held such that other entities are prevented from holding or reserving these resources while the hold is in place. Accordingly, temporarily held post-flight resources are reservable exclusively by passengers on the flight during the temporary hold period. The temporary hold lasts at least until airplane 110 arrives at its scheduled destination. The temporarily held post-flight resources may be allocated to the flight in response to an explicit request made by reservation manager 140 or an explicit request made by a resource allocation manager operative in terrestrial communication network 130, or may be allocated by terrestrial reservation system 160 independent of any request. Reservation manager 140 stores the received information about temporarily held post-flight resources in held resources database 320.

After departure, reservation manager 140 transmits information about the temporarily held post-flight resources to passenger interface 150 via inflight network interface 220 (420). The information may be broadcast to all passenger interfaces, multicast to selected passenger interfaces (e.g. interfaces in the first class part of the cabin), or unicast to passenger interfaces, such as passenger interface 150, that request the information. A passenger may, for example, make a menu selection or input a search query on a user screen of passenger interface 150 that prompts retrieval of the information from held resources database 320 and display of the information on the user screen.

Reservation manager 140 next receives a virtual reservation request for a post-flight resource from passenger interface 150 via inflight network interface 220 (430). A passenger may, for example, make a menu selection or input on a user screen of passenger interface 150 that prompts transmission the virtual reservation request. The virtual reservation request identifies the passenger making the reservation and the post-flight resource that the passenger wishes to reserve. The virtual reservation request may also include payment information, such as credit card information. Credit card information may be manually input on a user screen of passenger interface 150 or read from a credit card swiped through a credit card reader associated with passenger interface 150. Moreover, the virtual reservation request may include a post-flight contact address for the passenger, such as a phone number or an email address.

Reservation manager 140 next verifies that the virtual reservation request does not conflict with an existing virtual reservation (440). A conflict arises if, for example, two passengers on the same flight attempt to reserve the same resource. Reservation manager 140 compares the post-flight resource identification in the virtual reservation request with post-flight resource identifications stored in virtual reservations database 330 for previously accepted virtual reservation requests. If a match is found, there is a conflict and the flow proceeds to Step 450. If no match is found, there is no conflict and the flow proceeds to Step 460.

If there is a conflict, reservation manager 140 rejects the virtual reservation request and transmits a virtual reservation rejection to passenger interface 150 via inflight network interface 220 (450), whereupon the flow returns to Step 420. The rejection notifies the passenger via a message displayed on a user screen of passenger interface 150 that his or her virtual reservation request has not been fulfilled.

If there is no conflict, reservation manager 140 accepts the virtual reservation request. Reservation manager 140 stores the identification of the passenger and the reserved post-flight resource as an associated entry in virtual reservations database 330 and transmits a virtual reservation acceptance to passenger interface 150 via inflight network interface 220 (460), whereupon the flow returns to Step 420. Reservation manager 140 may also store as part of the associated entry contact information (e.g. phone number, email address) provided in the virtual reservation request. Reservation manager 140 may additionally store as part of the associated entry, in a secure area of virtual reservations database 330, payment information (e.g. credit card information) provided in the virtual reservation request. Reservation manager 140 may also remove the resource from held resources database 320 to prevent the resource from being offered to another passenger. The virtual reservation acceptance notifies the passenger via a message displayed on a user screen of passenger interface 150 that his or her virtual reservation request has been fulfilled. It bears noting that to this point, the accepted reservation is a “virtual” reservation since it has not yet been processed by terrestrial reservation system 160, although the temporary hold guarantees that the post-flight resource will be available when the reservation is processed by terrestrial reservation system 160.

After arrival of airplane 110 at the flight destination, reservation manager 140 establishes a wireless connection with terrestrial reservation system 160 on terrestrial communication network 130 and transmits actual reservation requests corresponding to accepted virtual reservation requests to terrestrial reservation system 160 via terrestrial network interface 210 (470). Each actual reservation request includes passenger and post-flight resource identifications retrieved from an associated entry in virtual reservations database 330, and may also include payment information and contact information. Multiple accepted virtual reservation requests may be bundled in a single actual reservation request to conserve bandwidth and expedite processing. Where a post-flight resource is of a type that requires verification of payment information and/or prepayment, terrestrial reservation system 160 verifies payment information and/or charges the passenger in accordance with payment information. Terrestrial reservation system 160 then accepts the actual reservation requests, resulting in actual reservations of the post-flight resources for the passengers being made, and transmits corresponding actual reservation acceptances to reservation manager 140 via terrestrial network interface 220. Naturally, where a post-flight resource requires verification of payment information and/or prepayment but terrestrial reservation system 160 is unable to verify payment information and/or charge the passenger, terrestrial reservation system 160 rejects the actual reservation request. In some embodiments, reservation manager 140 also transmits to terrestrial reservation system 160 via terrestrial network interface 210 an explicit request to release the temporarily held post-flight resources that were not virtually reserved, whereupon terrestrial reservation system 160 removes the temporary hold on those resources.

If inflight communication network 120 is still operative at this juncture, terrestrial reservation system 160 may transmit via reservation manager 140 an actual reservation acceptance to passenger interface 150. The actual reservation acceptance provides further confirmation to the passenger via a message displayed on a user screen of passenger interface 150 that his or her reservation request has been fulfilled. In lieu of or in addition to transmitting an actual reservation acceptance to passenger interface 150, terrestrial reservation system 160 may transmit over terrestrial communication network 130 an actual reservation acceptance to a contact address (e.g. phone number, email address) provided in the virtual reservation request. Where a post-flight resource required verification of payment information and/or prepayment but terrestrial reservation system 160 was unable to verify payment information and/or charge the passenger, terrestrial reservation system 160 may transmit via reservation manager 140 an actual reservation rejection that provides notification to the passenger via message displayed on a user screen of passenger interface 150 that his or her reservation request has not been fulfilled due to inability to verify payment information and/or prepayment.

It will be appreciated by those of ordinary skill in the art that the invention can be embodied in other specific forms without departing from the spirit or essential character hereof. For example, in some embodiments, a common or overlapping group of temporarily held post-flight resources may be allocated to multiple concurrent flights using a statistical model that accounts for reservation probabilities. These embodiments, where resource allocations are not exclusive to a single flight, are advantageous in that a greater share of the resources may be reserved by passengers across multiple flights than by passengers on a single flight. However, conflicting virtual reservations are possible in these embodiments and any conflicts must eventually be resolved, either by the terrestrial reservation system when making actual reservations or by the resource provider (e.g., airline, rental car company, hotel, etc.). The terrestrial reservation system or resource provider may employ a first-come, first-served or more egalitarian discipline (e.g., minimum guarantee for each flight) to resolve conflicting virtual reservations.

The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for virtual inflight reservation, comprising the steps of:
receiving by a reservation manager from a terrestrial reservation system information about temporarily held post-flight resources;
transmitting by the reservation manager to a passenger interface on an inflight communication network information about at least one resource within the temporarily held post-flight resources;
receiving by the reservation manager from the passenger interface a virtual reservation request for the resource; and
transmitting by the reservation manager to the terrestrial reservation system an actual reservation request for the resource based on the virtual reservation request.

2. The method of claim 1, wherein the reservation manager is connected to the terrestrial reservation system during the first receiving step and the second transmitting step and is disconnected from the terrestrial reservation system during the second receiving step and the first transmitting step.

3. The method of claim 1, wherein the reservation manager is operative on an airplane, and wherein the first receiving step and the second transmitting step are performed while the airplane is on the ground whereas the second receiving step and the first transmitting step are performed while the airplane is in-flight.

4. The method of claim 1, wherein the temporarily held post-flight resources comprise at least one of a flight seat, a rental car or a hotel room.

5. The method of claim 1, wherein the virtual reservation request comprises an identity of a passenger requesting a reservation and an identity of the resource.

6. The method of claim 5, wherein the virtual reservation request further comprises payment information.

7. The method of claim 5, wherein the virtual reservation request further comprises a post-flight contact address for the passenger.

8. The method of claim 1, further comprising the step of verifying by the reservation manager that the virtual reservation request does not conflict with an existing virtual reservation.

9. The method of claim 1, further comprising the step of storing by the reservation manager information from the virtual reservation request in a virtual reservations database.

10. The method of claim 1, further comprising the step of transmitting by the reservation manager to the passenger interface in response to the virtual reservation request a virtual reservation acceptance for the resource.

11. The method of claim 1, further comprising the step of receiving by the reservation manager from the terrestrial reservation system an actual reservation acceptance for the resource.

12. The method of claim 1, further comprising the step of transmitting by the reservation manager to the passenger interface an actual reservation acceptance for the resource.

13. The method of claim 1, further comprising the step of transmitting by the reservation manager to the terrestrial reservation system a request to release a temporary hold on resources within the temporarily held post-flight resources.

14. A virtual inflight reservation system, comprising:
a reservation manager; and
a passenger interface, wherein the reservation manager transmits to the passenger interface information about at least one resource within temporarily held post-flight resources identified to the reservation manager by a terrestrial reservation system, and wherein the reservation manager transmits to the terrestrial reservation system an actual reservation request for the resource based on a virtual reservation request for the resource received from the passenger interface and accepted by the reservation manager.

15. The system of claim 14, wherein the reservation manager is disconnected from the terrestrial reservation system when the reservation manager receives the virtual reservation request from the passenger interface and accepts the virtual reservation request.

16. The system of claim 14, wherein the reservation manager is operative on an airplane, and wherein the airplane is in-flight when the reservation manager receives the virtual reservation request from the passenger interface and is on the ground when the reservation manager transmits the actual reservation request to the terrestrial reservation system.

17. The system of claim 14, wherein the temporarily held post-flight resources comprise at least one of a flight seat, a rental car or a hotel room.

18. The system of claim 14, wherein the virtual reservation request comprises an identity of a passenger requesting a reservation and an identity of the resource.

19. The system of claim 18, wherein the virtual reservation request further comprises payment information.

20. The system of claim 18, wherein the virtual reservation request further comprises a post-flight contact address for the passenger.

21. The system of claim 14, wherein the reservation manager verifies that the virtual reservation request does not conflict with an existing virtual reservation.

22. The system of claim 14, wherein the reservation manager transmits to the passenger interface in response to the virtual reservation request a virtual reservation acceptance.

23. The system of claim 14, wherein the reservation manager receives from the terrestrial reservation system an actual reservation acceptance for the resource.

24. The system of claim 14, wherein the reservation manager transmits to the passenger interface an actual reservation acceptance for the resource.

25. The system of claim 14, wherein the reservation manager transmits to the terrestrial reservation system a request to release a temporary hold on resources within the temporarily held post-flight resources.

26. A reservation manager for a virtual inflight reservation system, comprising:
a terrestrial network interface;
an inflight network interface; and
a processor communicatively coupled with the terrestrial network interface and the inflight network interface, wherein under control of the processor the reservation manager transmits on the inflight network interface information about at least one resource within temporarily held post-flight resources identified to the reservation manager over the terrestrial network interface, and wherein under control of the processor the reservation manager transmits on the terrestrial network interface an actual reservation request for the resource based on a virtual reservation request for the resource received on the inflight network interface.

27. The reservation manager of claim 26, wherein the reservation manager is operative on an airplane, and wherein the airplane is in-flight when the reservation manager receives the virtual reservation request and is on the ground when the reservation manager transmits the actual reservation request.

28. The reservation manager of claim 26, wherein the temporarily held post-flight resources comprise at least one of a flight seat, a rental car or a hotel room.

29. The reservation manager of claim 26, wherein the virtual reservation request comprises an identity of a passenger requesting a reservation and an identity of the resource.

30. The reservation manager of claim 29, wherein the virtual reservation request further comprises payment information.

31. The reservation manager of claim 29, wherein the virtual reservation request further comprises a post-flight contact address for the passenger.

32. The reservation manager of claim 26, wherein the reservation manager under control of the processor verifies that the virtual reservation request does not conflict with an existing virtual reservation.

33. The reservation manager of claim 26, wherein the reservation manager under control of the processor transmits on the inflight network interface in response to the virtual reservation request a virtual reservation acceptance.

34. The reservation manager of claim 26, wherein the reservation manager under control of the processor receives on the terrestrial network interface an actual reservation acceptance for the resource.

35. The reservation manager of claim 26, wherein the reservation manager under control of the processor transmits on the inflight network interface an actual reservation acceptance for the resource.

36. The reservation manager of claim 26, wherein the reservation manager transmits on the terrestrial network interface a request to release a temporary hold on resources within the temporarily held post-flight resources.
